(19) United States
(12) Patent Application Publication
(10) Pub. No.: US 2003/0236087 A1
(43) Pub. Date: Dec. 25, 2003

(54) Variable bandwidth and bandwidth-on-demand communication systems

(76) Inventor: Stuart Philip Stenton, Gloucestershire (GB)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/426,037

(22) Filed: Apr. 30, 2003

(30) Foreign Application Priority Data
Apr. 30, 2002 (GB) 0209938.0

(51) Int. Cl. H04M 3/00

(52) U.S. Cl. 455/418; 455/550.1; 455/566

(57) ABSTRACT

A wireless communication network and method of providing feedback. The network includes at least one mobile wireless communication device for receiving a service from a service provider. The mobile device includes a feedback mechanism for requesting a user input and generating and sending a feedback message including the user input to the service provider. The feedback message indicates the quality of service received by the mobile device. At least one base station delivers the service from the service provider to the mobile device. The base station receives the feedback message generated by the mobile device from the mobile device. A feedback server connected to the base station processes, stores and activates the feedback message.

### FIELD OF INVENTION

This invention relates to variable bandwidth and bandwidth-on-demand communication systems and more particularly to variable bandwidth and bandwidth-on-demand wireless communication systems.

### BACKGROUND ART

Owners of mobile phones and other wireless communication devices typically subscribe to a communication network to enable use of the phone. The mobile phone user may also subscribe to services which can be made available over the network such as Internet connection, video and audio data streaming and the like.

In a Third Generation (3G) network architecture, the bandwidth over which various services are delivered to the mobile user can be varied or tailored in dependence upon the service provided or in accordance with the user's wishes. Some services like the receipt of Short Message Service (SMS) messages are well suited to “low bandwidth” communication channels whereas other services such as downloading initial pages from a website or the provision of streamed video and audio information are best suited to “high bandwidth” communication channels. Perusing a downloaded page from a website should not require any bandwidth. Of course, if a mobile user only uses lower bandwidth services, then they will be charged at a lower rate than a user making use of high bandwidth services, there being a pricing structure for the amount of bandwidth the user wishes to have the facility to consume. In this regard, bandwidth can be viewed as a commodity.

Currently, if a user is unsatisfied with the performance of the network, then the user simply moves to another network, there being little in the way of feedback which a mobile user can readily provide to a network. The provision of variable bandwidth and bandwidth-on-demand services, complicates the situation further because, if a user is able to select greater bandwidth so as to receive a service more quickly or to select a service with which is associated a higher bandwidth requirement, then the user should receive the benefit of that greater bandwidth. However, the provision of bandwidth over a wireless network is necessarily a shared resource which therefore may not always be available to all users requesting greater bandwidth in times of great demand. Thus, a mobile user requesting a high bandwidth may not necessarily receive delivery of the requested service over a high bandwidth communication channel, in which case it is most likely that the user will be dissatisfied with the service received.

### SUMMARY OF THE INVENTION

Accordingly, one aspect of the present invention provides a mobile wireless communication device for receiving a service from a service provider, the mobile device including a user interface to receive a user input and a feedback mechanism operable to request the user input and generate and send a feedback message incorporating the user input to the service provider, wherein the feedback message is indicative of the quality of service received by the mobile device.

Conveniently, the device has a default bandwidth and is operable to request an increase in bandwidth at which the service is provided.

Preferably, the device has a default bandwidth and the service is provided by the service provider at an increased bandwidth to the default bandwidth.

Advantageously, the mobile device incorporates a processor for executing a software routine, the software routine creating a display prompt requiring the user input.

Conveniently, the user input comprises the pressing of a key of a keypad of the mobile device, which key is defined by the software routine.

Preferably, the user prompt comprises a display prompt and includes a plurality of representations indicative of a level of quality of service received.

Advantageously, the feedback mechanism is activated after a service has been delivered.

Conveniently, the feedback mechanism is activated after a service is interrupted.

Preferably, the feedback mechanism is operable to send a short message service (SMS) message.

A further aspect of the present invention provides a mobile wireless communication device for receiving a service from a service provider, the mobile device including: a user interface to receive a user input; a feedback mechanism operable to request the user input and generate and send a feedback message incorporating the user input to the service provider; a processor for executing a software routine, the software routine creating a display prompt requiring the user input, the display prompt comprising a plurality of representations indicative of a level of quality of service received by the mobile device; a keypad having a plurality of keys associated with the plurality of representations, wherein the user input comprises the pressing of a key of the keypad associated with one of the plurality of representations indicative of the level of quality of service received by the mobile device.

Another aspect of the present invention provides a wireless communication base station for delivering a service from a service provider to a mobile wireless communication device and being operable to receive a feedback message generated by the mobile device from the mobile device after the service, the mobile device being operable to receive a user input and the feedback message incorporating the mobile device user input and the base station being connected to a feedback server to process, store and action the feedback message.

Conveniently, a pricing server is connected to the base station, the price for a service being influenced by the feedback message.

Another aspect of the present invention provides a wireless communication network including at least one base station embodying the invention and a plurality of mobile wireless communication devices.

A further aspect of the present invention provides a wireless communication network comprising: at least one mobile wireless communication device for receiving a service from a service provider, the mobile device including a user interface to receive a user input and a feedback mechanism operable to request the user input and generate and send a feedback message incorporating the user input to the service provider, wherein the feedback message is indicative of the quality of service received by the mobile device; at least one base station for delivering the service from the service provider to the mobile device, the base station being operable to receive the feedback message generated by the mobile device from the mobile device; and a feedback server connected to the at least one base station to process, store and action the feedback message.

Another aspect of the present invention provides a wireless communication network comprising: at least one mobile wireless communication device for receiving a service from a service provider, the mobile device including a user interface to receive a user input and the feedback mechanism operable to request a user input and generate and send a feedback message incorporating the user input to the service provider, wherein the feedback message is indicative of the quality of service received by the mobile device; at least one base station for delivering the service from the service provider to the mobile device, the base station being operable to receive the feedback message generated by the mobile device from the mobile device; a feedback server connected to the at least one base station to process, store and action the feedback message; and a pricing server connected to the base station, the price for the service being influenced by the feedback message.

A further aspect of the present invention provides a method of providing feedback from a mobile wireless communication device to a base station comprising the steps of: providing a service to a mobile wireless communication device; the mobile wireless communication device requesting a user input indicative of the quality of the service received; the mobile wireless communication device receiving the user input indicative of the quality of the service received; the mobile wireless communication device generating a feedback message incorporating the user input indicative of the quality of the service received; and the mobile wireless communication device sending the feedback message to the base station.

Another aspect of the present invention provides a method of operating variable bandwidth and bandwidth-on-demand wireless networks comprising at least a mobile wireless communication device, a base station and ancillary hardware components, the method comprising the steps of: providing a service to a mobile wireless communication device; the mobile wireless communication device receiving a user input indicative of the quality of the service received; the mobile wireless communication device generating a feedback message incorporating the user input indicative of the quality of the service received; and the mobile wireless communication device sending the feedback message to the base station; and re-allocating ancillary hardware components within the network with a view to increasing bandwidth to meet demand in response to the feedback message.

### BRIEF DESCRIPTION OF THE DRAWING

In order that the present invention can be more readily understood, embodiments thereof will now be described by way of example, with reference to the accompanying drawings, in which:

FIG. 1 is a schematic representation of a wireless communication network embodying the present invention for communication with wireless communication devices over variable bandwidth communication channels or bandwidth-on-demand; and

FIG. 2 is a schematic representation of a communication device embodying the present invention.

### DETAILED DESCRIPTION OF THE DRAWING

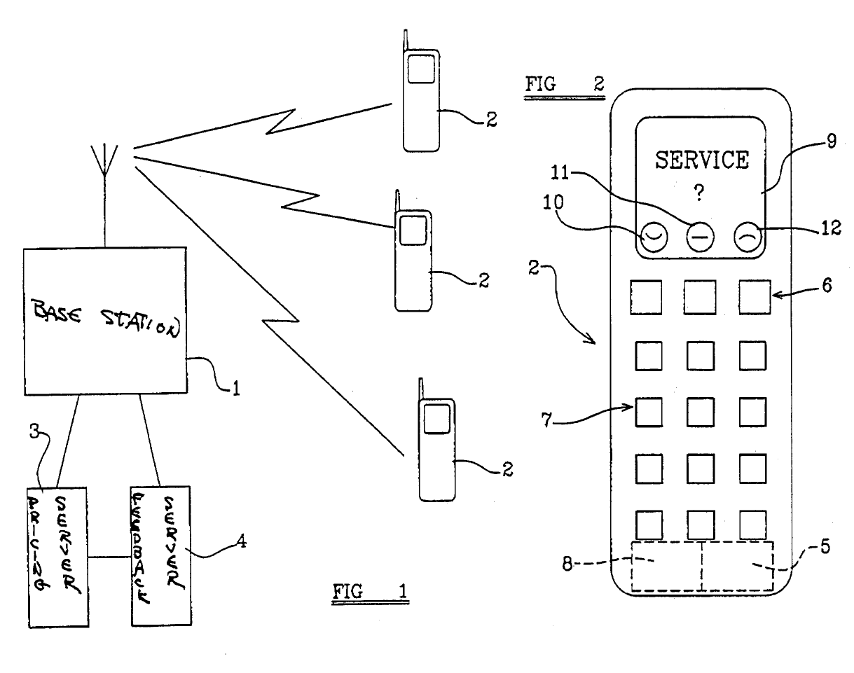

The present invention can be readily integrated within a conventional wireless communication network architecture offering variable bandwidth or bandwidth on demand capabilities, such as that shown schematically in FIG. 1. A base station 1 facilitates wireless communication with a plurality of mobile units 2 within the cell defined by the base station 1. The base station 1 is connected to or includes a pricing server 3 to collate billing information such as the volume of data transmitted between the base station 1 and each mobile unit 2 and the bandwidth at which a service requested of the base station 1 was delivered to each mobile unit 2.

As in a conventional network architecture, there is typically a default bandwidth allocated for “normal” communication between the mobile unit 2 and the base station 1 and the bandwidth of delivery of a requested service is dynamically adjusted to suit the service or, alternatively, the mobile user can request an increase or decrease in the bandwidth to suit their needs. Bandwidth is allocated to users of the network on a priority basis. When more bandwidth is required by a user, a request is made of the network and the user's priority is increased for access to the shared bandwidth. The network supports a basic telephone service as well as broadband services such as real time video streaming.

Preferably, the network architecture described above is a Third Generation (3G) architecture in which charges will be rendered to users not as a function of the time spent connected to the network but as a function of the volume of data or information received or transmitted over the network. A premium pricing rate can be attached, therefore, to users wishing to take advantage of high bandwidth. Thus, a user would expect to pay a premium rate for the delivery of a high bandwidth service.

However, a user should not feel constrained to pay for such a premium service if the service is not delivered. Conventionally, the user is unable to indicate to a network whether or not a service has been properly received at a high or increased bandwidth and, as previously discussed, a user is unable easily to take up bad service provision with the network or service provider.

The conventional network architecture shown in FIG. 1 is augmented at the base station 1 by an additional layer of functionality comprising, in hardware terms, a feedback server 4 connected to or included within the base station 1. The feedback server 4 processes, stores and actions feedback from mobile users. The feedback server 4 is preferably connected directly to the base station 1. The wireless communication devices, mobile units 2, operating within the cell are also augmented with a further layer of functionality comprising a feedback mechanism 5 operable to send feedback about the quality of service received by the mobile user back to the feedback server 4 attached to the base station 1. Referring to FIG. 2, the feedback mechanism 5 is realised in one example as a series of software defined keys 6 of the mobile unit keypad 7 and a software routine executed by a processor 8 within the mobile unit 2 upon completion or termination of a service provided over the network of FIG. 1.

Of course, the number of feedback options and the icons by which those options are represented on a display 9 of the mobile unit 2 may be defined by the network or service provider.

In operation, when a user indicates to the network that an increase in bandwidth is required or requests a service requiring an increased bandwidth, the change in bandwidth is noted by the network and appropriate information sent to a network billing centre by the pricing server 3 to charge that service at a premium rate. The ability and functionality required at the mobile unit 2 to request an increase in bandwidth is well known. Upon completion of the service or interruption of the service, the software routine in the mobile unit 2 executes on the processor 8 and prompts the user with a display requesting an indication of the quality of service experienced by the user. The display prompt may take the form shown on the display 9 of the mobile unit 2 in FIG. 2 of three icons 10, 11, 12 the first 10 representing a “smiling face” indicative of good quality of service, the second 11 representing a “straight” face indicative of an acceptable quality of service and the third 12 representing a “frowning” face indicative of an unacceptable quality of service.

The keys 6 of the keypad 7 immediately below the icons 10, 11, 12 are associated with the icons and defined by the software routine of the feedback mechanism 5 executed by the processor 8 so that once the key 6 associated with an icon 10, 11, 12, for example, underneath the relevant icon 10, 11, 12 is pressed, a feedback message is sent by the feedback mechanism 5 of the mobile unit 2 to the base station 1 and thence to the feedback server 4 connected thereto. Preferably, the feedback message is a Short Message Service (SMS) message incorporating the mobile users' choice of feedback (good, acceptable, unacceptable). On the base station side, various actions may be taken in response to the receipt from the mobile user of the feedback message. The feedback server 4 connected to the base station 1 collates the feedback messages received from the mobile units 2 and processes the same to spot trends and identify particular cells or particular peak times where the feedback messages indicate that inadequate bandwidth is being provided so that steps can be taken to remedy problems highlighted by the feedback. For example, hardware can be re-allocated within the network with a view to increasing bandwidth to meet demand. Thus the network can be tailored to meet the changing needs of its users, in response to demands by these users.

In some cases, no action needs to be taken in response to feedback messages. For example, the selection of a satisfied quality of service category by a user does not result in any further action being required by the user, whereas selection of an unacceptable quality of service category by the user may result in a simple message template being sent to the mobile unit 2 for completion to confirm the user's dissatisfaction with the service. Thus, the unacceptable category involves further enquiry from the network or the service provider and potential further follow-ups. The provision of follow-ups to the mobile unit 2 acts as a means for dissuading users from consistently indicating an unacceptable quality of service as the user may be called upon to justify their level of dissatisfaction. Communication by the feedback server 4 to the pricing server 3 of feedback information for a mobile unit 2 relating to a service can action a price reduction for a service deemed unsatisfactory by a user or that service may not be charged. Thus, the feedback can also influence the pricing structure.

The provision of quality of service feedback augmented into the hardware of conventional network architecture both at base stations 1 and at the mobile units 2, provides a layer of functionality which is not possible in existing networks which therefore suffer from customer exodus to competing networks where service is perceived as being better.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

What is claimed is:

1. A mobile wireless communication device for receiving a service from a service provider, the mobile device including a feedback mechanism operable to request a user input and generate and send a feedback message incorporating including the user input to the service provider, wherein the feedback message is indicative of the quality of service received by the mobile device.

2. A mobile device according to claim 1, wherein the device has a default bandwidth and is operable to request an increase in bandwidth at which the service is provided.

3. A mobile device according to claim 1, wherein the device has a default bandwidth and the service is arranged to be provided by the service provider at an increased bandwidth to the default bandwidth.

4. A mobile device according to claim 1, wherein the mobile device includes a processor for executing a software routine, the software routine being arranged to create a display prompt requiring the user input.

5. A mobile device according to claim 4, further including a key for providing the user input, the key being included on a keypad of the mobile device, the software routine being arranged for defining the key.

6. A mobile device according to claim 5, wherein the user prompt comprises a display prompt and includes a plurality of representations indicative of a level of quality of service received.

7. A mobile device according to claim 1, wherein the feedback mechanism is arranged to be activated after a service has been delivered.

8. A mobile device according to claim 1, wherein the feedback mechanism is arranged to be activated after a service is interrupted.

9. A mobile device according to claim 1, wherein the feedback mechanism is operable to send the feedback message including the user input to the service provider as a short message service (SMS) message.

10. A mobile wireless communication device for receiving a service from a service provider, the mobile device including a user interface for receiving a user input and a feedback mechanism operable to request the user input and generate and send a feedback message including the user input to the service provider, wherein the feedback message is indicative of the quality of service received by the mobile device.

11. A mobile wireless communication device for receiving a service from a service provider, the mobile device including:
a feedback mechanism operable to request a user input and generate and send a feedback message including the user input to the service provider;
a user interface for receiving the user input;
a processor for executing a software routine, the software routine being arranged for creating a display prompt requiring the user input, the display prompt comprising a plurality of representations indicative of a level of quality of service received by the mobile device;
a keypad having a plurality of keys associated with the plurality of representations, wherein the pressing of a key of the keypad associated with one of the plurality of representations indicative of the level of quality of service received by the mobile device is arranged to provide the user input.

12. A wireless communication base station for delivering a service from a service provider to a mobile wireless communication device and being operable to receive a feedback message generated by the mobile device from the mobile device after the service, the mobile device being operable to receive a user input and the feedback message including the mobile device user input and the base station being connected to a feedback server to process, store and action the feedback message.

13. A base station according to claim 10, wherein a pricing server is connected to the base station, the price for a service being arranged to be influenced by the feedback message.

14. A wireless communication network comprising:
at least one mobile wireless communication device for receiving a service from a service provider, the mobile device including a user interface for receiving a user input; a feedback mechanism operable to request the user input and generate and send a feedback message including the user input to the service provider, wherein the feedback message is indicative of the quality of service received by the mobile device;
at least one base station for delivering the service from the service provider to the mobile device, the base station being operable to receive the feedback message generated by the mobile device from the mobile device; and
a feedback server connected to the at least one base station for processing, storing and activating the feedback message.

15. A wireless communication network comprising:
at least one mobile wireless communication device for receiving a service from a service provider, the mobile device including a user interface for receiving a user input and a feedback mechanism operable to request the user input and generate and send a feedback message incorporating the user input to the service provider, wherein the feedback message is indicative of the quality of service received by the mobile device;
at least one base station for delivering the service from the service provider to the mobile device, the base station being operable to receive the feedback message generated by the mobile device from the mobile device;
a feedback server connected to the at least one base station for processing, storing and activating the feedback message; and
a pricing server connected to the base station, the price for the service being arranged to be influenced by the feedback message.

16. A method of providing feedback from a mobile wireless communication device to a base station comprising the steps of:
providing a service to a mobile wireless communication device;
the mobile wireless communication device requesting a user input indicative of the quality of the service received;
the mobile wireless communication device receiving the user input indicative of the quality of the service received;
the mobile wireless communication device generating a feedback message including the user input indicative of the quality of the service received; and
the mobile wireless communication device sending the feedback message to the base station.

17. A method of operating a variable bandwidth and bandwidth-on-demand wireless network having at least one mobile wireless communication device, a base station and ancillary hardware components, the method comprising the steps of:
providing a service to a mobile wireless communication device;
the mobile wireless communication device receiving a user input indicative of the quality of the service received;
the mobile wireless communication device generating a feedback message including the user input indicative of the quality of the service received; and
the mobile wireless communication device sending the feedback message to the base station; and
re-allocating ancillary hardware components within the network.

18. The method of claim 17 wherein the re-allocation results in increasing bandwidth to meet demand in response to the feedback message.
